(19) United States
(12) Patent Application Publication
(10) Pub. No.: US 2015/0088562 A1
(43) Pub. Date: Mar. 26, 2015

(54) RESTAURANT SELECTION, WAIT TIME AND ATTENDANCE MANAGEMENT

(71) Applicant: Celia Maria Woods, Cedar Grove, NJ (US)

(72) Inventor: Celia Maria Woods, Cedar Grove, NJ (US)

(21) Appl. No.: 14/034,847

(22) Filed: Sep. 24, 2013

(51) Int. Cl. G06Q 50/12; G06Q 10/02

(52) U.S. Cl. CPC G06Q 50/12; G06Q 10/02
USPC 705/5

(57) ABSTRACT

Techniques are provided for use, for example, in restaurant selection, wait time and attendance management, such as by an individual or group planning to attend a restaurant. At a Web site, a user may select a restaurant and be provided with the current wait time or estimated current wait time at the restaurant. The user may choose, via the Web site, to have a party added to the wait list for the restaurant, on condition that the party, or a specified portion of the party, must arrive at the restaurant a specified amount of time prior to expiry of the current wait time or current estimated wait time to avoid being removed from the wait list. The Web site may have arrangements with restaurants which may cooperate with the foregoing, including providing wait times to the Web site and adding online users to wait lists on conditions.

### BACKGROUND

Many people enjoy dining out, but not the wait. Wait times at restaurants can be long and difficult to predict, and can, for example, complicate selecting and attending a restaurant.

For example, a family may be at home and considering going out to a restaurant for dinner. There may be a number of good restaurants in the area. However, time may be tight and waiting to be seated, especially if the wait time is long, can be a real inconvenience or problem, particularly, for example, if the family includes kids. Furthermore, for example, wait times at particular restaurants can be difficult or inconvenient to find out about and manage.

### SUMMARY

Some embodiments of the invention provide systems and methods for use, for example, in restaurant (or other destination) selection, wait time and attendance management, such as by an individual or group planning to attend a restaurant. In some embodiments, at a Web site, a user may select a restaurant and be provided with the current wait time or estimated current wait time at the restaurant. The user may choose, via the Web site, to have a party added to the wait list for the restaurant, on condition, for example, that the party, or a specified portion of the party, must arrive at the restaurant a specified amount of time prior to expiry of the current wait time or current estimated wait time, for example, to avoid being removed from the wait list. The Web site may have arrangements with restaurants, which restaurants may cooperate with the foregoing, including providing wait times to the Web site and adding online users to wait lists on conditions.

Techniques according to embodiments of the invention can, for example, increase convenience and efficiency in restaurant selection, encourage restaurant attendance by increasing user information, control, and efficiency. Furthermore, restaurants can be benefitted in various ways including encouraging greater patronage and business, reducing congestion by reducing the number of customers waiting at the restaurant at a given time, and in other ways. Furthermore, in some embodiments, applications may be provided, whether at a Web site or locally, for use and convenience of users and restaurants.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

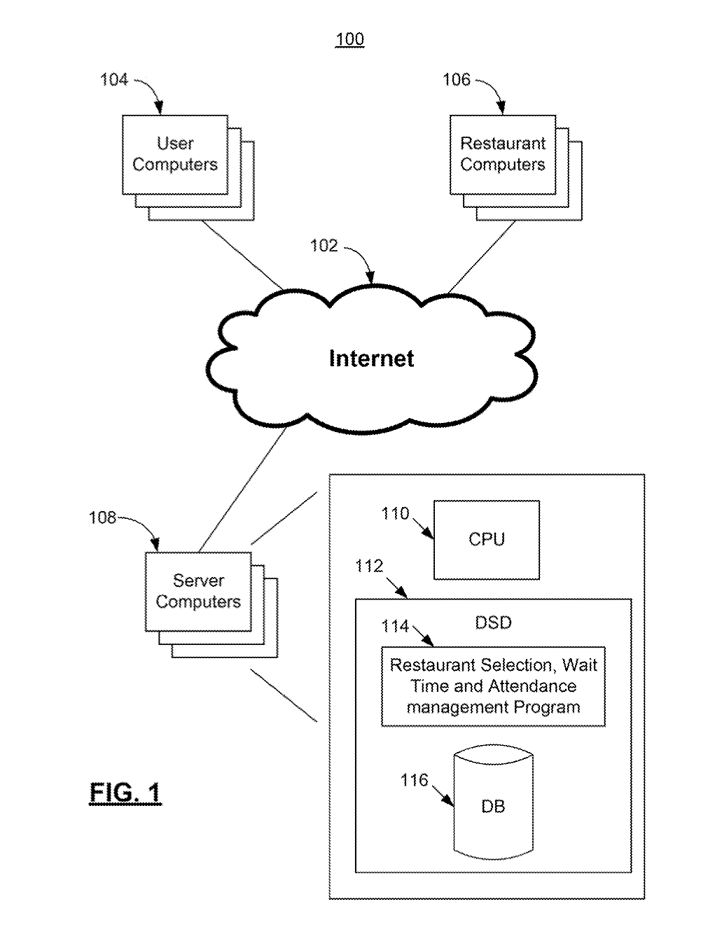

FIG. 1 is a distributed computer system 100 according to one embodiment of the invention. The system 100 includes user computers 104, restaurant computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and Restaurant Selection, Wait Time and Attendance Management Program 114.

The Program 114 is intended to broadly include all programming, applications, algorithms, software, engines, modules, functions, and other tools necessary to implement or facilitate methods and systems according to embodiments of the invention. The elements of the Program 114 may exist on a single server computer or be distributed among multiple computers or devices. In some embodiments, the Program 114 and the one or more server computer(s) may be used at, in connection with or in operation or support of a Web site that facilitates restaurant selection, wait time and attendance management.

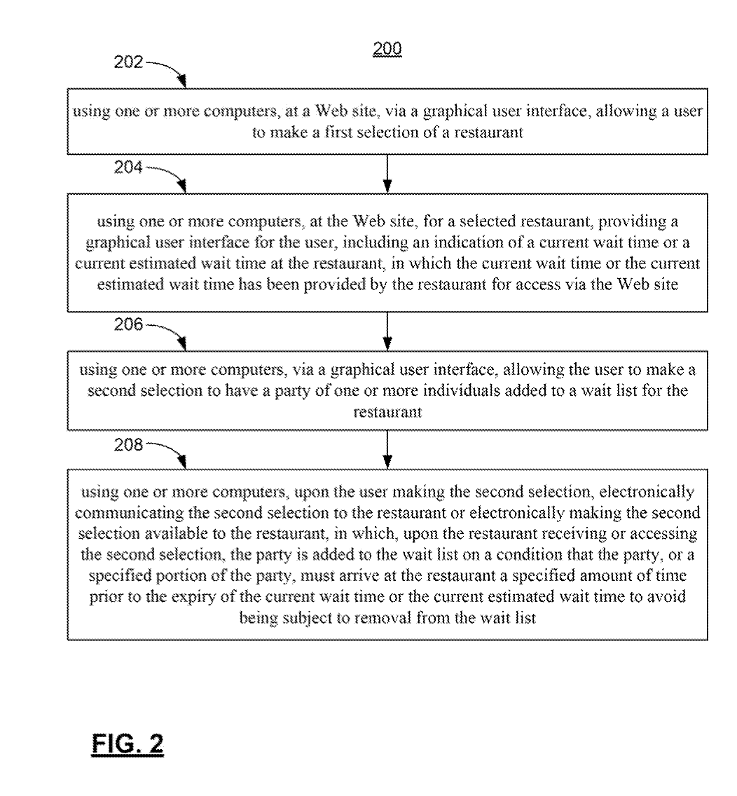

FIG. 2 is a flow diagram illustrating a method 200 according to one embodiment of the invention. Step 202 includes, using one or more computers, at a Web site, via a graphical user interface, allowing a user to make a first selection of a restaurant.

Step 204 includes, using one or more computers, at the Web site, for a selected restaurant, providing a graphical user interface (whether the same or different from other graphical user interfaces mentioned) for the user, including an indication of a current wait time or a current estimated wait time at the restaurant, in which the current wait time or the current estimated wait time has been provided by the restaurant for access via the Web site.

Step 206 includes, using one or more computers, via a graphical user interface (whether the same or different from other graphical user interfaces mentioned), allowing the user to make a second selection to have a party of one or more individuals added to a wait list for the restaurant.

Step 208 includes, using one or more computers, upon the user making the second selection, electronically communicating the second selection to the restaurant or electronically making the second selection available to the restaurant, in which, upon the restaurant receiving or accessing the second selection, the party is added to the wait list on a condition that the party, or a specified portion of the party, must arrive at the restaurant a specified amount of time prior to the expiry of the current wait time or the current estimated wait time to avoid being subject to removal from the wait list or some other negative consequence or penalty.

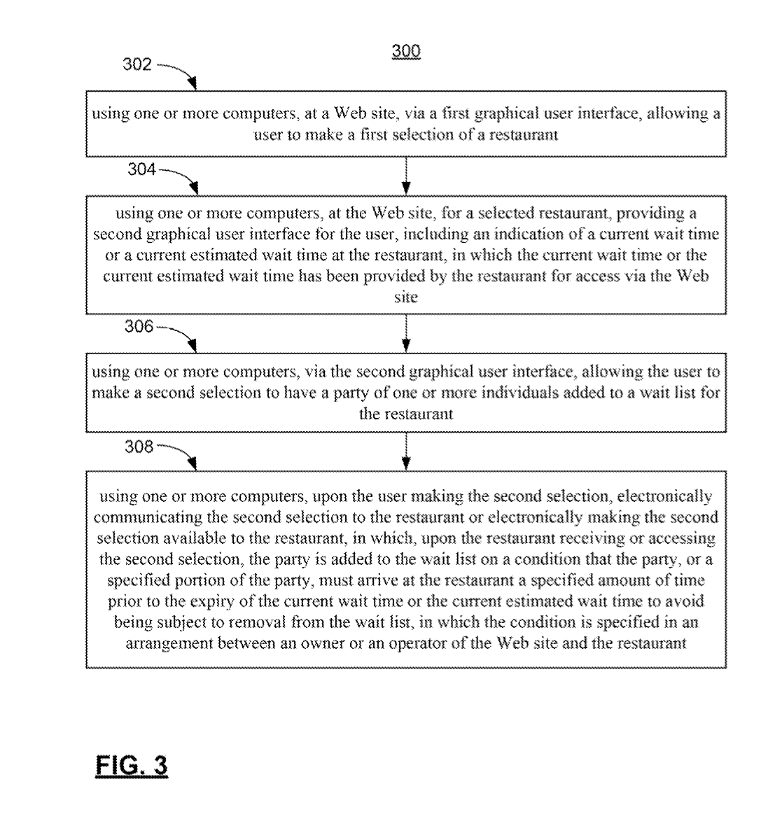

FIG. 3 is a flow diagram illustrating a method 300 according to one embodiment of the invention. Steps 302, 304 and 306 are similar to steps 202, 204 and 206 as depicted in the method 200 of FIG. 2.

Step 308 includes, using one or more computers, upon the user making the second selection, electronically communicating the second selection to the restaurant or electronically making the second selection available to the restaurant, in which, upon the restaurant receiving or accessing the second selection, the party is added to the wait list on a condition that the party, or a specified portion of the party, must arrive at the restaurant a specified amount of time prior to the expiry of the current wait time or the current estimated wait time to avoid being subject to removal from the wait list, in which the condition is specified in an arrangement between an owner or an operator of the Web site and the restaurant. In some embodiments, the Web site or an application used by the restaurant may facilitate wait list management for the restaurant, such as by adding parties, removing parties that do not meet a condition, etc.

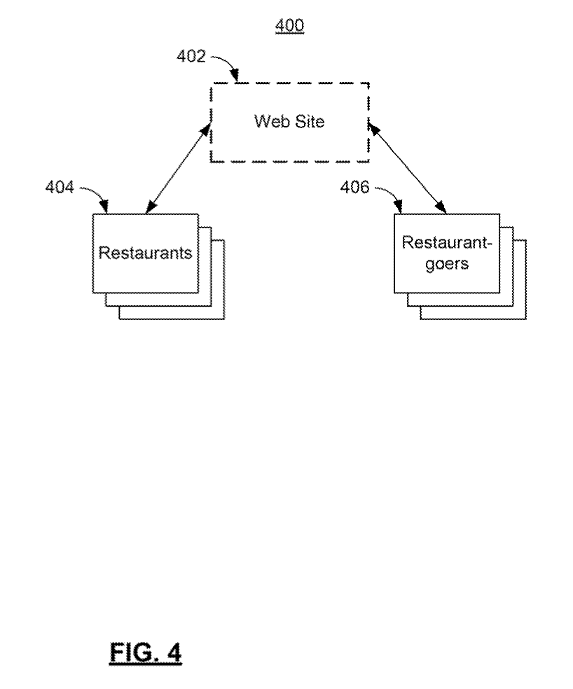

FIG. 4 is a block diagram 400 illustrating one embodiment of the invention. Depicted is a Web site 402, such as a Web site that facilitates restaurant selection, wait time and attendance management with use of a Restaurant Selection, Wait Time and Attendance Management Program. Also depicted are multiple restaurants 404 and multiple restaurant-goers 406.

In some embodiments, using computers, restaurants and restaurant goers utilize the Web site 402. For example, a restaurant goer user may use the Web site 402 (which can include accessing or interfacing with one or more Web pages of the Web site 402) to select restaurants, obtain information on current wait times or current estimated wait times at particular restaurants, and select to have a party put on a wait list of a particular restaurant, which may be subject to one or more conditions. For example, addition on the wait list may be on the condition that the party or a specified portion of the party arrive at the restaurant a certain amount of time prior to expiry of the current wait time or estimates current wait time when the user is added to the wait list, such as 5, 10 or 15 minutes before expiry. Failure to arrive by such time may, for example, cause the party to be removed from the wait list. Of course, other variations are possible, such as providing an estimated time of seating, rather than an estimated wait time, etc. Such conditions may be part of arrangements already in existence between an owner or operator of the Web site and the restaurant. Furthermore, users of the Web site, such as logged in or registered users, may be part of arrangements or agreements.

Furthermore, in some embodiments, restaurants also utilize the Web site, which can include an owner or an employee of a restaurant utilizing the Web site, such as from a computer at the restaurant, and/or may use an application provided by or at the Web site. For example, in some embodiments, arrangements are made between an owner or operator of the Web site and multiple restaurants. The restaurants may agree to be listed on the Web site and to participate in operations of the Web site. For example, a restaurant may agree that current wait times at the restaurant will be provided to users of the Web site.

Furthermore, a restaurant may agree, for example, that it will allow users to add a party to its wait list even though the party is not present at the restaurant, on condition, for example, that the party be subject to removal, if the party, or a specified portion or percentage of the party, does not arrive at the restaurant at least a certain amount of time prior to expiry of a current wait time or estimated wait time when the party is added to the wait list. In some embodiments, this can benefit the restaurant, among other ways, by reducing the amount of customers waiting at the restaurant at a given time.

Still further, the restaurant may agree to facilitate Web site operations, such as by, during certain days and hours, providing current wait times or estimated wait times, such as by providing updated wait times every certain amount of time, such as every 15 minutes, etc.

In some embodiments, when a user chooses to be added to a wait list of a restaurant via the Web site, the Web site communicates, or makes available to the restaurant, the choice or selection. The restaurant may then add the user's party to the wait list, whether independently or with or using the Web site, an application associated with the Web site. In some embodiments, the Web site, or an application associated with the Web site, electronically adds the party to the wait list for the restaurant, of facilitates such.

In some embodiments, restaurants may benefit from participation by obtaining customers through the Web site. Furthermore, in some embodiments, restaurants may provide advertisements, special offers or coupons via the Web site, or provide rewards for users that attend the restaurant following user of the Web site to be added to the restaurant's wait list.

In some embodiments, users benefit from participation in a number of ways. A user can select a restaurant based in part on current wait times for multiple restaurants, which may include multiple searched for, local, or selected restaurants, etc. The user can then select to be put on a wait list for a selected restaurant, but does not have to arrive at the restaurant until closer to an anticipated time of seating, saving time and increasing convenience.

In some embodiments, users may be registered with or log into the Web site. Furthermore, once added to a wait list at or by the Web site, the user may be provided with a reminder or alert. For example, in some embodiments, a user may be sent a text or notification to the user's mobile device or mobile phone when a certain amount of time is left until anticipated seating, etc.

Some embodiments include providing an app, or application, either for users, restaurants, or both. Furthermore, some embodiments, whether through one or more applications or otherwise, may make use of readable or scannable items, markings or codes, such as QR codes. For example, in some embodiments, instead of or in addition to getting on a wait list through a Web site, a restaurant may post a QR code, such as in a window, that may be readable by a user. The user may scan the QR code to, for example, find out the current wait time, get on a wait list if the user has not already done so, or check the updated amount of time left for waiting if the user is already on the wait list.

In some embodiments, restaurants may also use the Web site to obtain information on other restaurants' wait times, or other information, such as information on local, proximate, or competitive restaurants also participating in operations of the Web site. Furthermore, in some embodiments, the Web site allows competition between restaurants, such as by a restaurant attempting to provide a shorter wait time than a competitive restaurant, or by providing discounts or offers to users to better compete, etc. As such, in some embodiments, techniques are provided that provide an ecosystem, or competitive ecosystem, among restaurants, or among restaurants and users, etc.

In some embodiments, one or more applications, which may include one or more mobile applications, may be made available to restaurant goer users of the Web site, as well as to restaurants that use the Web site. An application may, for example, run on a smart phone of a restaurant goer user, enabling convenient user of Web site operations or offerings, or an application may run on a computer or computer system of a restaurant, enabling, for example, convenience or efficient communications between the restaurant and the Web site.

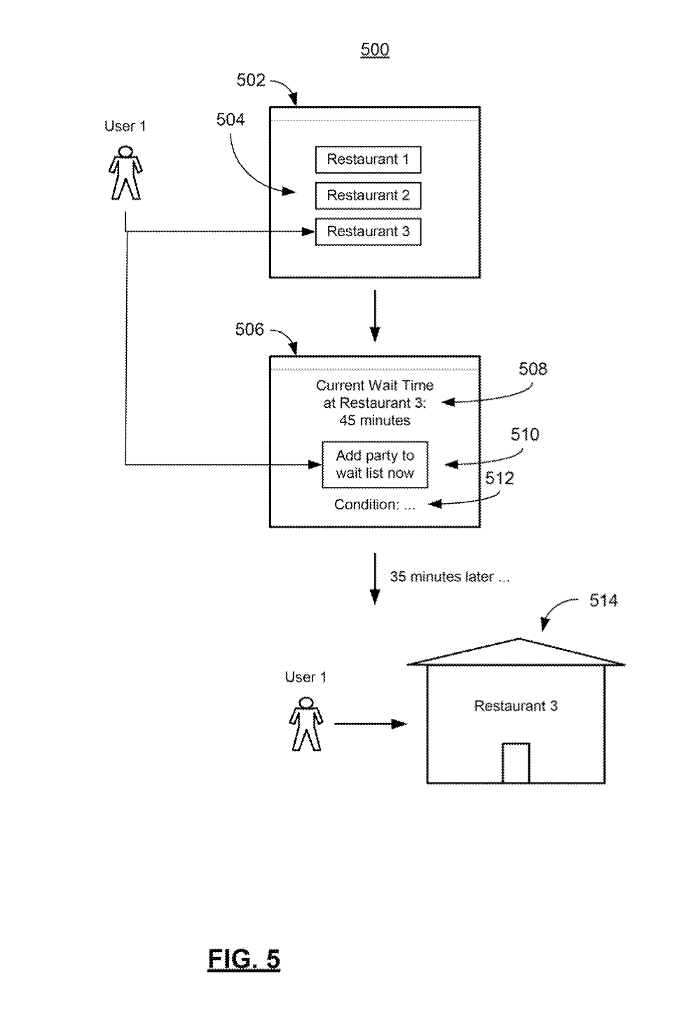

FIG. 5 is a block diagram 500 illustrating one embodiment of the invention. As depicted, a restaurant goer user, User 1, at a Web page of a Web site, is provided with a graphical user interface 502 including multiple possible restaurant selections 504, including, as depicted, Restaurant 1, Restaurant 2 and Restaurant 3.

As depicted, User 1 selects Restaurant 3 and is then provided with another graphical user interface 506 (or, in other embodiments, the same graphical user interface), indicating the current wait time or estimated current wait time at Restaurant 3 508, and allowing the user to make a selection 510 to have a party added to the wait list. Although not depicted, other details and interactions are possible, such as the user providing details such as the number of people in the party, number of adults and children, special requests or requirements, etc. Furthermore, the graphical user interface 508 may provide an indication of a condition 512 that the user arrive at the restaurant at a certain time, or a certain amount of time prior to anticipated seating or expiry of the current wait time or estimated wait time.

As depicted, following addition of the party to the wait list, and at least a certain amount of time prior to expiry of the current wait time or estimated current wait time when the party was added to the wait list, the party, which may be the user, User 1, arrives at Restaurant 3.

While the invention is described with reference to the above drawings, the drawings are intended to be illustrative, and the invention contemplates other embodiments within the spirit of the invention.

1. A method comprising:
using one or more computers, at a Web site, via a graphical user interface, allowing a user to make a first selection of a restaurant;
using one or more computers, at the Web site, for a selected restaurant, providing a graphical user interface for the user, including an indication of a current wait time or a current estimated wait time at the restaurant, wherein the current wait time or the current estimated wait time has been provided by the restaurant for access via the Web site;
using one or more computers, at the Web site, via a graphical user interface, allowing the user to make a second selection to have a party of one or more individuals added to a wait list for the restaurant; and
using one or more computers, upon the user making the second selection, electronically communicating the second selection to the restaurant or electronically making the second selection available to the restaurant, wherein, upon the restaurant receiving or accessing the second selection, the party is added to the wait list on a condition that the party, or a specified portion of the party, must arrive at the restaurant a specified amount of time prior to the expiry of the current wait time or the current estimated wait time to avoid being subject to removal from the wait list.

2. The method of claim 1, wherein the condition is specified in an arrangement between an owner or an operator of the Web site and the restaurant.

3. The method of claim 1, wherein the condition is specified to the user via a display on the Web site.

4. The method of claim 1, wherein a text message is sent to the user to alert the user when a specified amount of time is left before an anticipated time of seating for the party.

5. The method of claim 1, wherein the restaurant adds the party to the wait list after receiving the selection.

6. The method of claim 1, wherein the Web site adds the party to the wait list, in accordance with arrangements between the owner or operator of the Web site and the restaurant.

7. The method of claim 1, wherein the first graphical user interface and the second graphical user interface are provided via an application provided by or associated with the Web site.

8. The method of claim 1, wherein the wherein the first graphical user interface and the second graphical user interface are provided on a mobile device of the user.

9. The method of claim 1, wherein the user is registered or logged in user relative to the Web site.

10. The method of claim 1, comprising, at the Web site, providing a graphical user interface accessible by an employee or owner of the restaurant, through which a current wait time may be entered.

11. The method of claim 1, comprising, via the Web site, allowing a restaurant to view wait times at other restaurants.

12. The method of claim 1, comprising, via the Web site, allowing a restaurant to view wait times at other restaurants, and allowing competition between restaurants relating to providing wait times to users.

13. The method of claim 1, wherein the Web site comprises multiple Web pages.

14. A system comprising:
one or more server computers coupled to a network; and
one or more databases coupled to the one or more server computers;
wherein the one or more server computers are for:
at a Web site, via a first graphical user interface, allowing a user to make a first selection of a restaurant;
at the Web site, for a selected restaurant, providing a second graphical user interface for the user, including an indication of a current wait time or a current estimated wait time at the restaurant, wherein the current wait time or the current estimated wait time has been provided by the restaurant for access via the Web site;
via the second graphical user interface, allowing the user to make a second selection to have a party of one or more individuals added to a wait list for the restaurant; and
upon the user making the second selection, electronically communicating the second selection to the restaurant or electronically making the second selection available to the restaurant, wherein, upon the restaurant receiving or accessing the second selection, the party is added to the wait list on a condition that the party, or a specified portion of the party, must arrive at the restaurant a specified amount of time prior to the expiry of the current wait time or the current estimated wait time.

15. The system of claim 14, wherein restaurant wait times or estimated wait times are stored in at least one of the one or more databases.

16. The system of claim 14, wherein the condition is specified in an arrangement between an owner or an operator of the Web site and the restaurant.

17. The system of claim 14, wherein the condition is specified to the user via a display on the Web site.

18. The system of claim 14, wherein a text message is sent to the user to alert the user when a specified amount of time is left before an anticipated time of seating for the party.

19. The system of claim 14, wherein the restaurant adds the party to the wait list after receiving the selection.

20. A computer readable medium or media containing instructions for executing a method comprising:
using one or more computers, at a Web site, via a first graphical user interface, allowing a user to make a first selection of a restaurant;
using one or more computers, at the Web site, for a selected restaurant, providing a second graphical user interface for the user, including an indication of a current wait time or a current estimated wait time at the restaurant, wherein the current wait time or the current estimated wait time has been provided by the restaurant for access via the Web site;
using one or more computers, via the second graphical user interface, allowing the user to make a second selection to have a party of one or more individuals added to a wait list for the restaurant; and
using one or more computers, upon the user making the second selection, electronically communicating the second selection to the restaurant or electronically making the second selection available to the restaurant, wherein, upon the restaurant receiving or accessing the second selection, the party is added to the wait list on a condition that the party, or a specified portion of the party, must arrive at the restaurant a specified amount of time prior to the expiry of the current wait time or the current estimated wait time to avoid being subject to removal from the wait list, wherein the condition is specified in an arrangement between an owner or an operator of the Web site and the restaurant.
